(19) United States
(12) Patent Application Publication
(10) Pub. No.: US 2018/0349496 A1
(43) Pub. Date: Dec. 6, 2018

(54) METHOD FOR INDEXING OF VIDEODATA FOR FACETED CLASSIFICATION

(71) Applicant: LLC "Synesis", Moscow (RU)

(72) Inventors: Nikolai Vadimovich PTITSYN, Moscow (RU); Pavel Alexandrovich SAPEZHKO, Orsha (BY); Anton Nikolaevich GRABKO, Bobruisk (BY)

(21) Appl. No.: 15/552,964

(22) PCT Filed: Jul. 7, 2017
(86) PCT No.: PCT/RU2017/000504

§ 371 Date: Aug. 23, 2017

(30) Foreign Application Priority Data
Jun. 1, 2017 (RU) 2017119182

(51) Int. Cl. G06F 17/30; G06K 9/00

(52) U.S. Cl. CPC G06F 17/30858; G06F 17/30784; G06K 9/00624; G06K 9/00362; G06F 17/30598

(57) ABSTRACT

The invention relates generally to video data processing and storage, including video surveillance and television, and uses video data indexing and faceted search in video data sets. The method for indexing of video data by facet characteristics is wherein the video data containing facet characteristics are written into the data storage, wherein at least one combination of at least two facet characteristics relating to the video data is generated; each combination counter is increased by at least one; and then the search for video data is run in the data storage, wherein only those facet combinations are used whose counters have positive values; the video data is removed from the data storage, wherein each facet combination counter relating to the removed video data is decreased by at least one. The objective is to lower resource demands for data search in video data sets by means of faceted classification.

### CROSS-REFERENCE TO RELATED APPLICATIONS

This application is a US National Phase of PCT/RU2017/000504, filed on Jul. 7, 2017, which claims priority to RU 2017119182, filed on Jun. 1, 2017, which are both incorporated by reference herein in their entirety.

### BACKGROUND OF THE INVENTION

### Field of the Invention

The present technical solution relates generally to computing systems. More specifically, it relates to the field of video data processing and storage, including the areas of video surveillance and television. The solution is aimed at video data indexing and faceted search in video data sets.

### Description of the Related Art

Conventional systems for processing and storage of video data usually utilize universal storages (data storage systems) and databases (database management systems). Video data is received from video data sources, such as cameras or user mobile devices, then the video data divided into fragments and uploaded to a data storage as objects or files. Fragment sizes are determined with regard to optimal speed of reading and/or writing of objects (files) in the storage. A registry of objects or files stored is usually kept in the database. Some systems upload video data in cycles. Such systems operate on a notion of video archive depth, i.e., a maximum time period for storing the received video data. Stored video data fragments can be defined by multiple characteristics, such as video data source (location and type of recording), recording fragment length and timestamp, length and timestamp of an event in the recording fragment, access rights for the recording fragment, types and characteristics of objects the recording fragment contains, types and characteristics of events the recording fragment contains, types and characteristics of external events related to the recording fragment, identifiers of objects the recording fragment contains, user-generated text comments to the recording fragment, etc.

Characteristics of objects and events in video recordings are determined using video content analysis algorithms, including those based on image recognition and machine learning. The characteristics determined by video content analysis algorithms may include, e.g., gender and age of a person, their hair color, clothing color, or type and color of a vehicle.

Recording fragment indices, as well as object and event indices are usually stored in a database. These indices are used to establish connections between objects (files) in the data storage and fragment characteristics. They also enable quick search through recordings without requiring to read and process large amount of video data.

Search queries in systems for processing and storing of video recordings usually include not one, but multiple recording or event characteristics, in other words, employ faceted classification of recording fragments, i.e., objects and events therein. The results of such a search query may include cross references or matches in multiple recording fragments that correspond to the specified characteristics. New indices appear, which, in turn, are synthesized with each other through combination of characteristics according to a facet formula. When the amount of stored video recordings and/or the number of objects (events) therein become considerable, i.e., the data turn into “big data”, existing systems for processing and storing of video recordings face performance problems. Processing of search queries demands lots of resources when working with recording indices, which leads to longer waiting times and more expensive hardware required.

A conventional solution is disclosed in U.S. Pat. No. 7,860,817 B2, entitled “System, method and computer program for facet analysis”, issued on Dec. 28, 2010. This solution uses an automated facet analysis of input selected from the information field in accordance with the original data structure. Facet analysis may be performed by detecting at least one facet characteristic, facet attributes and their hierarchy in the input using template augmentation and statistical analysis to identify correlations between facet characteristics in the input. However, this patent does not disclose how to solve the computational problems when working with large data sets. In particular, it does not disclose using facet counters or their combinations to decrease the database load when processing the user's search query.

Another conventional solution is disclosed in U.S. Pat. No. 9,588,989 B2, entitled “Search systems and computer-implemented search methods”, issued on Mar. 7, 2017. This solution describes search systems and search methods implemented therein. In one embodiment, the search system includes a communications interface that is able to access multiple data elements in a collection, wherein the data elements include multiple image objects. In another embodiment, facet characteristics (features) include only counters of basic objects, which are connected to facet attributes. However, this patent also does not disclose how to solve the computational problems when working with large data sets, as it does not disclose creating individual basic object counters for facet combinations or facet hierarchy. In order to determine the number of basic objects in a search query, which includes two or more facet characteristics, it is necessary to actually count the objects, in which the characteristics correlate.

### SUMMARY OF THE INVENTION

The present technical solution is aimed at overcoming the drawbacks of existing solutions.

An object of the invention is to optimize computing algorithms for indexing and information search in video data sets by means of faceted classification.

Another object of the invention is to lower resource demands for data search in video data sets by means of faceted classification. Another object is to increase the speed of counting of objects with specified facet characteristics; to increase the speed of generating of statistical reports and charts for certain facet characteristics; to lower the total time needed to search for information; to increase the speed of search with text (symbol) field; and to control the integrity of stored video data.

Yet another object is to increase the precision of dealing with user-generated search queries, as well as to increase the speed of notifying the user about the size of event (video data) selection without actually counting all events identified during the processing of a query.

To achieve these objectives, a method for indexing of video data by facet characteristics is proposed, wherein the video data containing facet characteristics are stored in the data storage, wherein at least one combination of at least two facet characteristics relating to the video data is generated; each combination counter is increased by at least one; and then the search for video data is run in the data storage, wherein only those facet combinations are used, whose counters have positive values; finally, the video data is removed from the data storage, wherein each facet combination counter relating to the video data removed is decreased by at least one.

In some embodiments of the invention, when the video data is stored in the storage, at least one more aggregate counter is also generated, which sums up two or more other facet counters, wherein the aggregate counter increases together with the counters it sums.

In some embodiments of the invention, facet counters form a hierarchy through aggregation.

In some embodiments of the invention, when the video data is stored in the storage, counters are either increased or decreased by a certain N, where N is the number of indexed events in the video data input.

In some embodiments of the invention, an absolute or relative time period relating to video data writing time is considered a facet characteristic. In some embodiments of the invention, the video data source is considered a facet characteristic. In some embodiments of the invention, the characteristic of user or group of users having access to the stored video data is considered a facet characteristic.

In some embodiments of the invention, motion detected in the relevant video data is considered a facet characteristic. In some embodiments of the invention, the result of processing of video data with video- and/or audio content analysis algorithms is considered a facet characteristic. In some embodiments of the invention, the characteristic or identifier of a human is considered a facet characteristic.

In some embodiments of the invention, the characteristic or identifier of a vehicle is considered a facet characteristic. In some embodiments of the invention, an event of an external system integrated into the video surveillance system is considered a facet characteristic.

In some embodiments of the invention, a user tag or comment is considered a facet characteristic. In some embodiments of the invention, when the video data is stored in the storage, a database index is also used for text- and number-based search through video data facet characteristics. In some embodiments of the invention, multiple counters are distributed among multiple computing nodes.

In some embodiments of the invention, a facet counter is used to control the display of a relevant facet characteristic by the Graphical User Interface (GUI). In some embodiments of the invention, a facet counter is used to estimate the number of search results in video data.

To achieve the above mentioned objectives, a system for processing and storage of video data by facet characteristics is also used, the system comprising a video data storage and a data processing device, in which the video data containing facet characteristics are written into the data storage, wherein at least one combination of at least two facet characteristics relating to the video data is generated; each combination counter is increased (incremented) by at least one; then, the search for video data is run in the data storage, where only those facet combinations are used, whose counters have positive values; and finally, the video data is removed from the data storage, where each facet combination counter relating to the video data removed is decreased (decremented) by at least one.

Additional features and advantages of the invention will be set forth in the description that follows, and in part will be apparent from the description, or may be learned by practice of the invention.

The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification and together with the description serve to explain the principles of the invention.

In the drawings:

FIG. 1 shows an exemplary design of a video surveillance system with faceted search.

FIG. 2 illustrates writing indexed video data into the data storage.

FIG. 3 illustrates an exemplary faceted search in indexed video data.

FIG. 4 illustrates removing indexed video data from the data storage.

FIG. 5 shows an exemplary counter structure for faceted search through video data.

FIG. 6 shows an exemplary graphical user interface (GUI) for a video surveillance system with faceted search.

FIG. 7 shows an exemplary computer or server on which the invention may be implemented.

### DETAILED DESCRIPTION OF THE PREFERRED EMBODIMENTS

Reference will now be made in detail to the preferred embodiments of the present invention, examples of which are illustrated in the accompanying drawings.

Faceted classification of data means that the original set of video data (events) is divided into subsets, grouped by mutually independent classification features, i.e., facets or facet characteristics. Video data elements and events may be represented as lying on intersections between some facet characteristics, where video data indices are determined by combining facet characteristics in accordance with a facet formula. The present invention uses multiple counters for each facet combination or some of those combinations, which the user can use to search through the video data archive. The counters store the already-calculated number of events or other tags in the stored video data, and can be used to exclude empty search branches. The counters can also be used to inform the user about a possible number of results of their search query for each facet combination, without actually calculating the number of events (tags) in the database during the user session. The counters can be stored in the database along with the main index of the video archive.

The invention can be implemented as a computer-based or electronic-based system that performs the commands required by the above-mentioned method. The invention can also be implemented as a distributed system.

The terms used in the discussion are given below:

System is a computer based system, a cloud server, a cluster, a computer, a control system, a programmable logical controller (PLC), a computer-based controlling system or other devices that are capable of performing a sequence of operations (actions, commands).

Storage is a cloud data storage, a data storage system, a data storage network, or a net-based storage which may comprise but are not limited to hard drives (HDD), flash drives, read-only memory (ROM), solid-state drives (SSD), optical drives, dedicated or virtualized servers. To ensure horizontal scalability of the storage for big data, Ceph-based storage objects may be used.

Big data is a set of approaches, tools and methods for processing huge amounts of data and providing wide variety of human-perceived results, which are effective under the conditions of continuous growth and distribution among multiple computing nodes. Within the present invention, big data means video data amounts of 10 PB and more, with more than 3,000 video data sources.

Facet formula is an order that determines the sequence of facets and inter-facet connectors in the classification index.

Faceted classification is a classification system, where notions are represented as a faceted structure, and classification indices are synthesized through combinations of facet characteristics in accordance with the facet formula.

Facet characteristic is a classification feature used to group notions into facets.

Facet is a complex (set) of all subclasses in the classification system, resulting from division of a class according to a single classification feature.

Indexing is a process of assigning conventional values and generating links (indices) to simplify access to video data.

Video content analysis is a complex (set) of computer vision techniques for automated acquisition of various data based on analysis of a sequence of images received from video cameras either in real time or from an archive.

Event is a fact of something to have taken place and to have been registered in the video data.

The present method for indexing of video data by means of faceted classification can be implemented in a system for processing and storage of video data at three stages of video data processing at the same time, namely (a) when the video data is stored in the storage; (b) when a search through video data is run; and (c) when the video data is removed from the storage. Below is the detailed description of preferred embodiments of the technical solution for each of above mentioned stages.

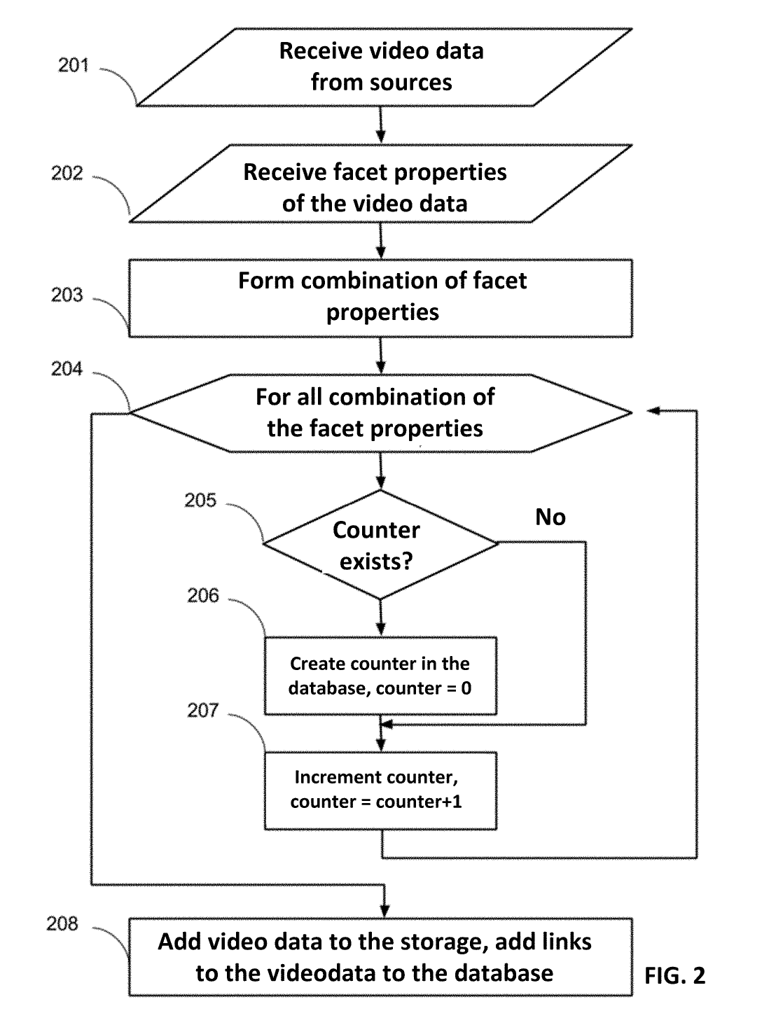

Before the video data is written into the storage (see FIG. 2), they have to be obtained from a source. There are several possible video data sources, including:
a video sensor, a camera, or a video coder;
a network-based video server, a digital video recorder, a video storage server, which may be represented as a standard or a specialized computer with disk or solid-state memory for video storage;
a mobile device, a smartphone, or a tablet equipped with a camera;
a person or an organization that have created a recording or a film.

The video data source, as well as every other component of the system, such as the storage or the computing node, may be virtualized, i.e., they are not limited by physical embodiments or the geographical location of the hardware.

Video data may be received in a stream (frame by frame) or in packets (a set of frames or a video fragment). In video surveillance systems, the received video data is characterized by facet characteristics, including at least a location and time of registration. In video broadcast-on-request systems, the received video data is also characterized by facet characteristics that include, e.g., the movie genre and release year.

In some embodiments of the present invention, facet characteristics may be expanded with other characteristics based on events or objects that the received video data contains. Thus, the received video data is processed by software algorithms of video and/or audio content analysis. Facet characteristics are also generated using the algorithms, e.g., by means of deep-learning neural networks. The algorithms generate event-based or other marking of video data according to the facet characteristics. These event-generating algorithms may include, but are not limited to, algorithms for recognition of faces, vehicle number plates, sounds, as well as other algorithms for or other algorithms for detecting, following and classification of objects in the camera's field of view. The facet characteristics may be expanded with, e.g., the following video data characteristics obtained using software or hardware algorithms, such as motion or absence thereof, an object of a specific type (a person, a group of people, a motorcycle, a car, a truck, a train), a person's face and its features (gender, age, race, glasses, mustache, beard or other distinctive features), a vehicle and its features (type, color, license plate, motion parameters), or accompanying sounds (noise, shouts, shots). The video data may be processed with these algorithms either on the fly, as soon as the video data is received, or in packages, at a later time.

In some embodiments of the present invention, facet characteristics may be expanded with other characteristics based on events retrieved from external systems, e.g., events of an access control and management system, events of a security fire alarm, events of an accounting system, events of a ticketing system, events from external or additional sensors, etc.

In some embodiments of the present invention, facet characteristics may be expanded with identifying characteristics of specific persons and vehicles, e.g., person's full name or vehicle license plate number.

In some embodiments of the present invention, facet characteristics may be expanded with other characteristics based on user-generated events, e.g., user's text comments, specific marks and tags, or a specific level of danger.

In some embodiments of the present invention, facet characteristics may be expanded with other characteristics based on distribution or division of access rights among system users or system-generated video data tags.

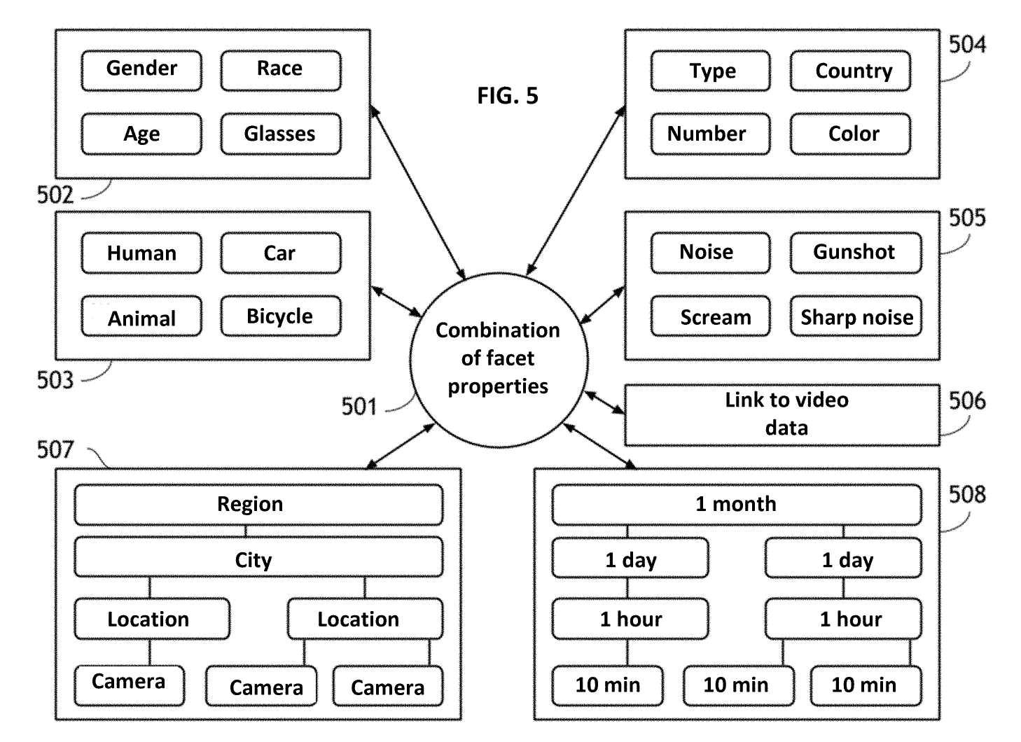

In some embodiments of the present invention, facet characteristics may be expanded with aggregate characteristics. Facet characteristics may be aggregated by hierarchy. For example, as shown in FIG. 5, if characteristics are aggregated by time, then the aggregate characteristics will correspond to time intervals of 10 min, 1 hour, 1 day. If characteristics are aggregated by territory/geography, then the aggregate characteristics will correspond to individual cameras, addresses, towns, geographic regions. If characteristics are aggregated by access to information, then the aggregate characteristics will correspond to user groups and subgroups. If characteristics are aggregated by event type, then the aggregate characteristics will form a hierarchical classification of event types.

In accordance with the present invention, at least one combination of at least two facet characteristics (including aggregate ones) is generated. For example, the following combination of three characteristics can be used, namely video data source ID, time period of recording, event type. In other words, such combination will look for an event, which satisfies the conditions that a person's face was detected by a specified camera during a specified time period.

Optimum facet combinations may be suggested based on the objectives of the system, frequency of search queries on the relevant features, speed and time requirements to the system. New combinations may be added “on the fly” when video data with a new facet characteristic is obtained.

The example below of calculating the total number of characteristics illustrates the mechanism of creating facet combinations:

| | | Aggregate | |
|---|---|---|---|
| Physical sense of a facet | Independent facet | (dependent) facet | Sum of independent and |
| characteristic | characteristics | characteristics | dependent facet characteristics |
| Event date and time in the | 4,320 | 720 time quanta | 5,070 |
| archive with depth of 30 days | time quanta (10 min | with hourly | time facets |
| | each) | aggregation + | |
| | | 30 time quanta with | |
| | | daily aggregation | |
| Camera location (address) | 100,000 cameras | 10,000 locations | 110,010 |
| | | with 10 cameras | location facets |
| | | each + | |
| | | 10 cities with | |
| | | 10,000 cameras | |
| | | each | |
| Human face detection | 4 facets: | 3 facets: | 7 |
| | Male face, | Male face + | face facets |
| | no glasses + | Female face + | |
| | Male face, | All faces | |
| | wearing glasses + | | |
| | Female face, | | |
| | no glasses + | | |
| | Female face, | | |
| | wearing glasses | | |

The calculation of facet combinations looks as follows: (5,070 time facets)×(110,010 location facets)×(7 face facets)=3,904,254,900 facet characteristics. For each of them, an individual counter may be created, though in actual practice, there will be significantly fewer counters, as events usually appear during a limited period of time and in a limited number of video data sources.

Then, for all facet combinations associated with the received video data, a check is run, whether there are associated counters in the database. If there are none, a counter is created, initialized and set to 0.

The values of all counters found or newly created for the received video data is increased by 1.

If there are aggregate characteristics in the combination, all counters in the same hierarchy are increased by 1.

In some embodiments of the present invention, for example, when there are multiple events of a certain type in the received video data, the counters are immediately increased by the needed number.

Then, the received video data and facet characteristics associated with them are written into the data storage. An indexing link to the video data written is generated and written into the database. The link may be an entry in the database that contains a link to the file or some other video data object ID that is stored in the data storage. Information about video data events along with their respective facet characteristics are also written into the database.

In some embodiments of the present invention, the video data source ID (camera name and address), along with date and time of receiving video data, identifiers and features of persons and vehicles detected in the video data, and links to the key frames are written into the database. For example, using face recognition algorithms connected to the database of wanted persons, such person identifiers as first name, last name, passport number can be obtained, while such person's characteristics as age, gender and race can be determined. Vehicle recognition algorithms can also return vehicle identifiers (license number plates), as well as such features as state/region, color, type and make.

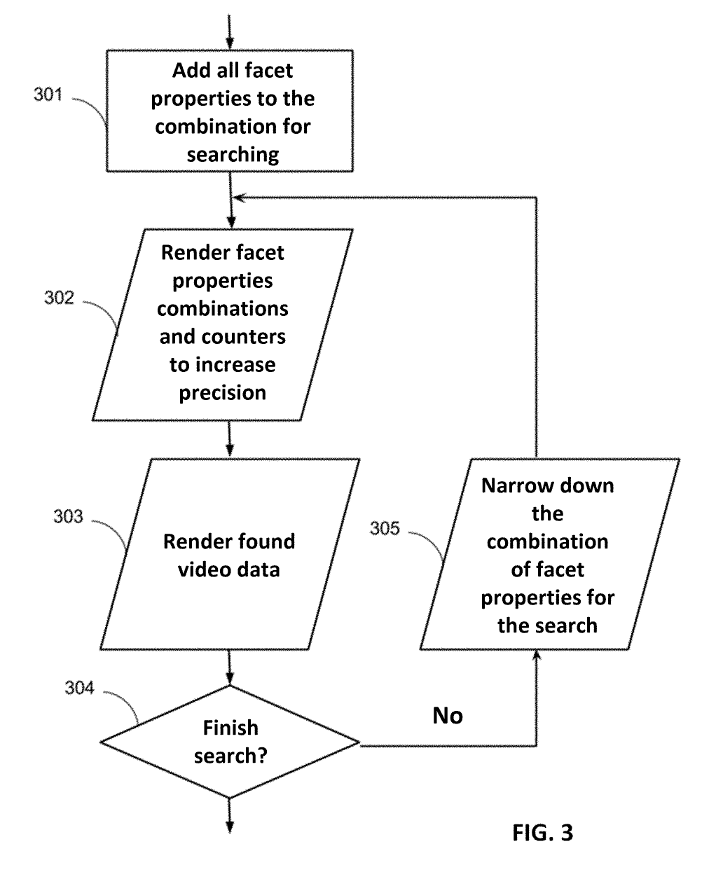

At the stage of faceted search in indexed video data (see FIG. 3), the names of facet characteristics in one or more combinations, which have counter values higher than 0, are first displayed in the GUI.

In some embodiments of the present invention, counter values are displayed opposite corresponding facet characteristics, the values reflecting the number of search results after they have been filtered by a particular facet characteristic.

If the user has already selected some characteristics or combinations thereof for the search, then only those counter values are considered, which are associated with the selected characteristics. If there is no counter for the combination selected by the user, then the number of events can be obtained by adding up (or subtracting) available counters for the characteristics in the combination.

Then, the user-generated search query is used to search for video data, events, sources (e.g., cameras) or other data in the database. To do that, at least one database query is generated, the query including the combination of facet characteristics selected by the user. The search itself is run only for the combinations, which have counter values higher than 0, since zero-value combinations are not displayed to the user.

Then, a limited number of search results with regard to the characteristics selected by the user is displayed.

Search results may be displayed as tiles (frames from video data), dots on a map or blueprints, showing locations where video data sources are placed, or as event lists, tables and graphs. In case the user is not satisfied by the search results, the user may provide a new set of characteristics to further refine or expand the search query.

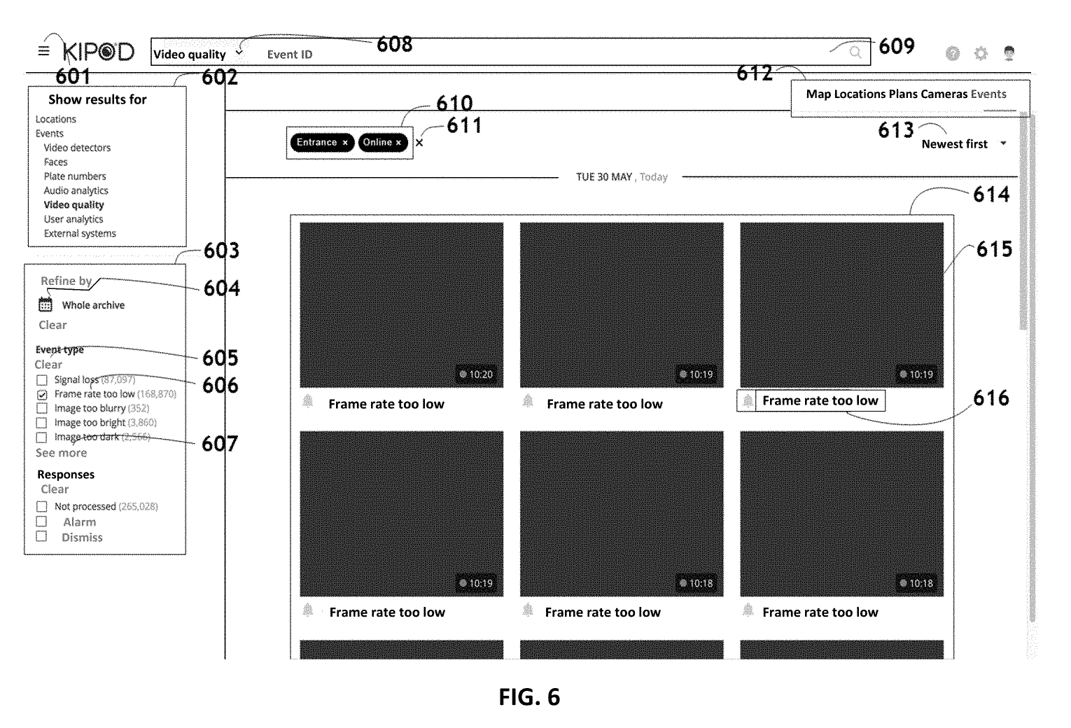

The steps described above are repeated until the user is satisfied with the search results. The GUI for faceted search in video data is shown in FIG. 6.

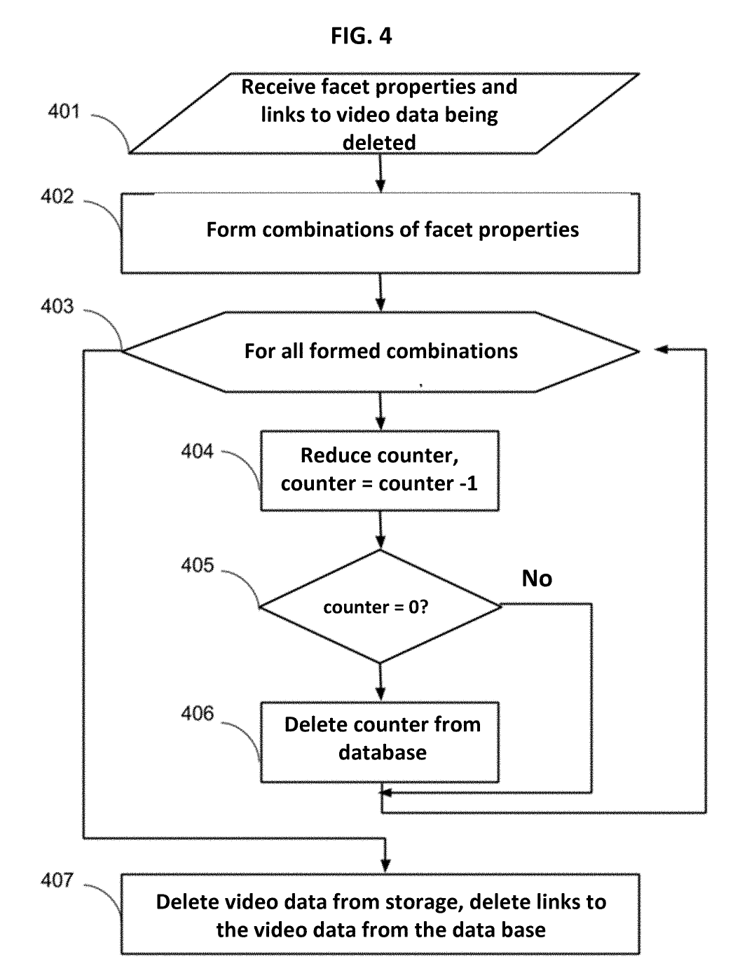

At the stage of removing indexed video data from the storage (see FIG. 4), first the video data to be removed have to be identified. If automatic removal is set up, then the video data to be removed are identified by the time facet, which has an earlier value than the archive depth. Video data can also be removed manually, when requested by the user. The facet characteristics and links to the video data to be removed from the storage are retrieved from the database. All counters, which are associated with the combinations containing characteristics of the video data to be removed, are decreased by 1 or N events. If combinations with aggregate facets are in use, then all counters in the same hierarchy are decreased by 1 or N at the same time. If the counter value is 0, the counter is deleted. Then the video data itself are removed from the storage, along with their event information and facet characteristics. Finally, indexing links are also removed from the database.

According to yet another embodiment of the present invention, an exemplary system capable of implementing the present technical solution includes a data processing device that can be configured as a client, a server, a mobile device, or any other computing device that interacts with the data in a network-based cooperation system. The most basic configuration includes, typically, at least one CPU and data storage. Depending on the exact configuration and the computing device type, the system memory may be either volatile (e.g., RAM), or non-volatile (e.g., ROM), or some combination thereof. The data storage device includes, typically, one or more applications and may also include their data. The present technical solution—method described in full detail above—can be implemented as an application.

The data processing device may have additional features or functions, e.g., it may comprise additional data storage devices, both fixed and removable, such as magnetic disks, optical disks, tape, etc. Computer-based data carriers may include both volatile and non-volatile carriers, as well as fixed and removable ones, which are implemented in any way and with any technology of information storage, such as machine-readable instructions, data structures, software modules, etc. Data storage devices, both fixed and removable, are examples of computer-based data carriers. Other computer-based carriers may include, but are not limited to, random access memory (RAM), read-only memory (ROM), electrically erasable programmable ROM (EEPROM), flash memory or other memory technology; CD-ROMs, DVDs or any other optical memory devices; as magnetic tapes, cassettes, magnetic disc storages or any other magnetic storage; or any other media that can be used for storing of desirable information and that can be accessed by the data processing device. Any such computer-based data carrier can be a part of the system. The data processing device may also comprise an input device, such as a keyboard, a mouse controller, a stylus, a voice input device, a sensor input device, etc., as well as an output device, such as a display, speakers, a printer, etc.

The data processing device includes communications connections that allow the device to communicate with other computing devices, e.g., via a network, including local and global networks, along with other large scalable network, including but not limited to, corporate networks and extranets. The communications connection is an example of a communications environment. This environment can be implemented, as a rule, by employing machine-readable commands, data structures, software modules or other data in a modulated information signal, such as a carrier wave, or by any other transportation mechanism, the environment also including all information delivery media. The term “modulated information signal” means a signal, one or more characteristics of which have been modified or set in order to encode information the signal carries. As a non-limiting example, communications environments may include both wired environments, such as a wired network or a direct wired connection, and wireless environments, such as acoustic, radio frequency, infrared, etc. environments. The term “machine-readable medium”, as used in the present disclosure, means both data carriers and communications environments.

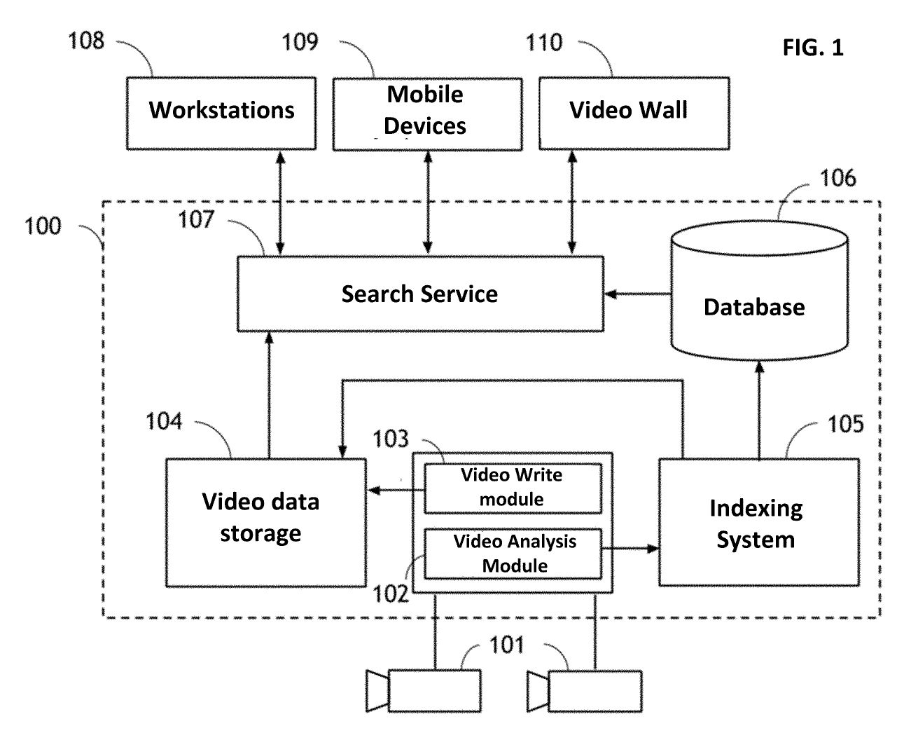

FIG. 1 shows an exemplary design of a video surveillance system with faceted search. The components of the surveillance system shown in the figure bear the following markings:

100—video processing and storage system;

101—video data sources (cameras);

102—video analysis unit;

103—video recording unit;

104—video data storage;

105—indexing system;

106—database;

107—search utility to serve clients;

108—user workstations;

109—user mobile devices;

110—video walls.

Video streams from external video data sources (101) are processed by video content analysis algorithms in the video analysis unit (102), while the video recording unit (103) writes the video into the storage (104). The video analysis unit (102) may employ algorithms for recognition of faces, vehicle number plates, sounds, or other algorithms for detecting, following and classification of objects in the camera's field of view. The output of video analysis algorithms in the unit (102) contains events and metadata, which are then written into the indexing system (105) that processes input events according to the present invention and then writes the events and indices the database management system (106) and video data storage system (104).

Also, the indexing unit (105) can remove events and metadata after their storage life expires, according to the present invention.

Clients represented by workstations via web-based access (108), mobile devices (109) or video walls (110) may request data on events through the search utility (107). The events, processed by video analysis algorithms, will be displayed on the client's GUI.

FIG. 2 illustrates writing of indexed video data into the data storage. In some embodiments of the present invention, the algorithm for putting video data into the storage comprises the following steps:

receiving video data from sources (201);

receiving facet characteristics for the video data (202);

generating combinations of the characteristics (203);

for each combination generated (204), a check is run, whether the combination has an associated counter (205);

a new counter is created, initialized and set to 0 (206), if necessary, and then is increased by 1 (207);

video data is stored in the storage, and links to them are written into the database (208).

FIG. 3 illustrates an exemplary faceted search in indexed video data.

In some embodiments of the present invention, faceted search in indexed video data is run in iterations, using the sequential approximation method. First, a search query is generated as a combination of facet characteristics, comprising all facet characteristics available (301). The GUI displays the names of each characteristic in the combination (302). Opposite each characteristic, the value of an associated counter is displayed, which reflects the number of results based on the characteristic (302). The found video data is displayed as tiles (frames), a list or a video sequence (303). If the user wants to continue the search (304), they have to refine the query by adding or removing facet characteristics (305). The steps (302), (303), (304) and (305) are repeated until the search yields satisfactory results.

FIG. 4 illustrates a method of removing indexed video data from the data storage.

In some embodiments of the present invention, the algorithm for removing video data from the storage comprises the following steps:

receiving facet characteristics and links to the video data to be removed (401);

generating facet combinations (402);

for each combination generated (403), the associated counter is decreased by 1 (404);

then, a check is run to see whether the counted value has reached 0 (405), and the counter may be removed from the database (406), if necessary;

the video data associated with the link are removed from the storage, and the link is removed from the database (407).

FIG. 5 shows an exemplary counter structure for faceted search through video data.

In some embodiments, the counter structure may include the following groups of counters:

501—event;

502—face characteristics;

503—object characteristics;

504—vehicle characteristics;

505—audio signal characteristics;

506—video data fragments;

507—video data source characteristics;

508—time characteristics.

FIG. 6 shows an exemplary graphical user interface (GUI) for a video surveillance system with faceted search.

The video data search panel is visible by default. It can be hidden, if necessary, by clicking the “Hide” button (601). If the button is clicked again, the search panel is displayed.

The user sets search parameters by switching between facet categories (602) and group filters based on facet characteristics (604) associated with each category. Opposite each characteristic, a number of events is shown, based on the associated counter. Depending on the specified categories and facet filters, the right-hand part of the screen is filled with the search results (613).

The categories include the list of groups along with the number of objects the categories contain. Only some of the available groups are visible by default, though the complete list may be viewed by clicking the “More” option (603), the list including:
1. Locations;
2. Views;
3. Cameras;
4. Events:

1. Video detectors;

2. Faces;

3. Number plates;

4. Audio content analysis;

5. Video quality control;

Having selected a category (602), the user sets search parameters in filters based on facet characteristics (604), which are unique for each category selected, and also sets the time and date in the calendar (605), if the archive is to be searched.

The example shows groups of filters based on facet characteristics by time (calendar) and video data source (location, camera). Other groups, such as event type, priority, operator's replies, etc. are outside the screenshot.

All groups of filters use the AND operator, while inside each group the OR operator is at work. If no element from the filter group is selected, it is considered to be disabled, and the facet combination will include all characteristics from a group.

The search results (613) are automatically shown to the right from the search panel in one of the following tabs (608):
Map;
Locations;
Views;
Cameras;
Events.

When selecting or deselecting a facet characteristic in the group of filters, the filter list and search results are refreshed. Counter values associated with events may also shift. This is how the iteration search is carried out using the sequential approximation method, i.e., by refining facet characteristics in filters.

For instance, the “Events” tab contains the frames of events in video data (614). When hovering the mouse cursor over such frame (614), an enlarged image of the object detected by the video analysis is displayed, along with the event ID (its number in the database). The event frame also contains the date and time the event was detected.

When clicking the event snapshot (614), a media player opens and starts playing back the video. The accompanying information (616) is displayed under the snapshot, the information including event description, camera name, view and location names. Under each event there is a button that opens a hidden options menu (615), which allows to add an event to the “Reply” form: either “Add to a new reply” or “Add to an existing reply”.

The filters selected by the user (611) are displayed above the search results. The user may reset all filters either by clicking the “Close” buttons by each filter or by clicking the “Clear” button (612) located to the right of the facet filter list (611).

The “Reset” option (606) on the search panel under the filter name(s) also allows to clear facet characteristics selected by the user as search parameters. At the same time, search results field is also cleared, and the latest relevant data are uploaded to the central part of the window.

The “Sort by ascending date” option (609) allows viewing events beginning from archived ones to the present ones. If the “Sort by descending date” option is selected, the same drop-down list (609) will display the latest relevant data on the top of the list (613).

The text search field in the upper part of the window (607) allows searching for events based on the following criteria:
event ID;
vehicle license plate number;
person's last name;
operator's comment.

The user can change the results screen appearance (613) by switching through available viewing modes using the button in the top right corner (610).

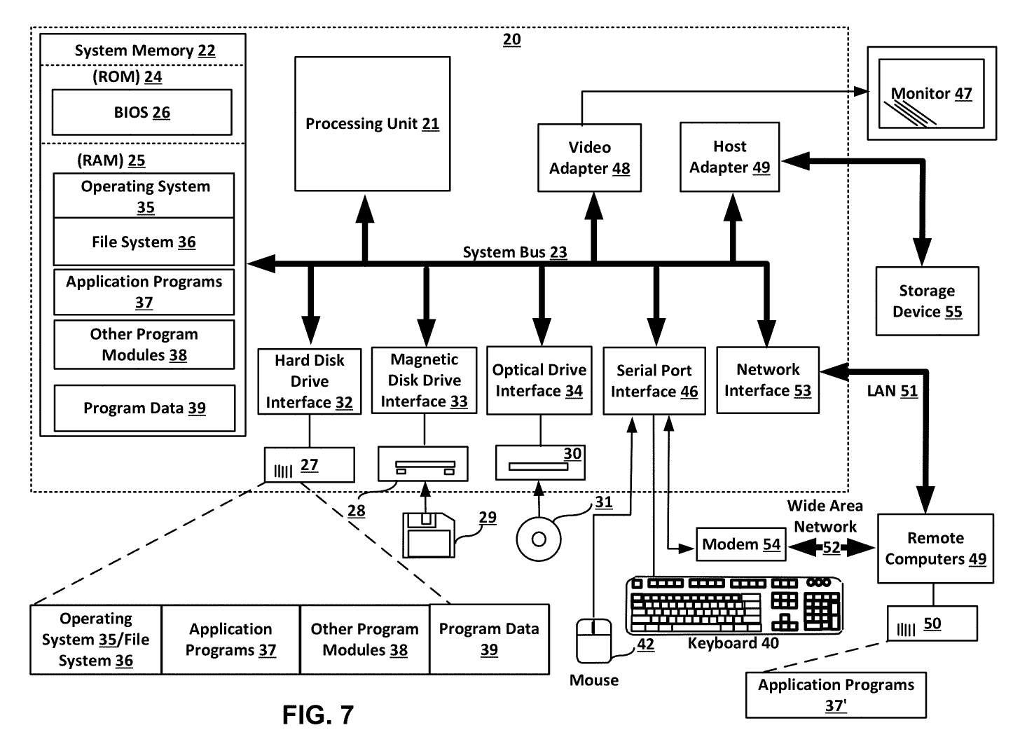

With reference to FIG. 7, an exemplary system for implementing the invention includes a general purpose computing device in the form of a host computer or a server 20 or the like, including a processing unit (CPU) 21, a system memory 22, and a system bus 23 that couples various system components including the system memory to the processing unit 21.

The system bus 23 may be any of several types of bus structures including a memory bus or memory controller, a peripheral bus, and a local bus using any of a variety of bus architectures. The system memory includes a read-only memory (ROM) 24 and random access memory (RAM) 25. A basic input/output system 26 (BIOS), containing the basic routines that help to transfer information between the elements within the computer 20, such as during start-up, is stored in ROM 24.

The computer or server 20 may further include a hard disk drive 27 for reading from and writing to a hard disk, not shown herein, a magnetic disk drive 28 for reading from or writing to a removable magnetic disk 29, and an optical disk drive 30 for reading from or writing to a removable optical disk 31 such as a CD-ROM, DVD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively.

The drives and their associated computer-readable media provide non-volatile storage of computer readable instructions, data structures, program modules and other data for the server 20. Although the exemplary environment described herein employs a hard disk (storage device 55), a removable magnetic disk 29 and a removable optical disk 31, it should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk (storage device 55), magnetic disk 29, optical disk 31, ROM 24 or RAM 25, including an operating system 35 (e.g., MICROSOFT WINDOWS, LINUX, APPLE OS X or similar). The server/computer 20 includes a file system 36 associated with or included within the operating system 35, such as the Windows NT™ File System (NTFS) or similar, one or more application programs 37, other program modules 38 and program data 39. A user may enter commands and information into the server 20 through input devices such as a keyboard 40 and pointing device 42.

Other input devices (not shown) may include a microphone, joystick, game pad, satellite dish, scanner or the like. These and other input devices are often connected to the processing unit 21 through a serial port interface 46 that is coupled to the system bus, and they may also be connected by other interfaces, such as a parallel port, game port or universal serial bus (USB). A monitor 47 or other type of display device is also connected to the system bus 23 via an interface, such as a video adapter 48. In addition to the monitor 47, computers typically include other peripheral output devices (not shown), such as speakers and printers. A host adapter 49 is used to connect to the storage device 55.

The server/computer 20 may operate in a networked environment using logical connections to one or more remote computers 49. The remote computer (or computers) 49 may be another personal computer, a server, a router, a network PC, a peer device or other common network node, and it typically includes some or all of the elements described above relative to the server 20, although here only a memory storage device 50 with application software 37′ is illustrated. The logical connections include a local area network (LAN) 51 and a wide area network (WAN) 52. Such networking environments are common in offices, enterprise-wide computer networks, Intranets and the Internet.

In a LAN environment, the server/computer 20 is connected to the local network 51 through a network interface or adapter 53. When used in a WAN networking environment, the server 20 typically includes a modem 54 or other means for establishing communications over the wide area network 52, such as the Internet.

The modem 54, which may be internal or external, is connected to the system bus 23 via the serial port interface 46. In a networked environment, the program modules depicted relative to the computer or server 20, or portions thereof, may be stored in the remote memory storage device. It will be appreciated that the network connections shown are merely exemplary and other means of establishing a communications link between the computers may be used.

The claimed subject matter has been provided here with reference to one or more features or embodiments. Those skilled in the art will recognize and appreciate that, despite the detailed nature of the exemplary embodiments provided here, changes and modifications may be applied to the embodiments without limiting or departing from the generally intended scope. These and various other adaptations and combinations of the embodiments provided here are within the scope of the disclosed subject matter as defined by the claims and their full set of equivalents.

Having thus described the invention, it should be apparent to those skilled in the art that certain advantages of the described apparatus have been achieved. It should also be appreciated that various modifications, adaptations, and alternative embodiments thereof may be made within the scope and spirit of the present invention. The invention is further defined by the following claims.

What is claimed is:

1. A method for indexing of video data by facet characteristics, comprising:
writing the video data containing facet characteristics into a data storage, including
generating at least one combination of at least two facet characteristics relating to the video data; and
increasing each combination counter by at least one;
performing a search for video data in the data storage,
wherein only those facet combinations whose counters have positive values are used; and
removing the video data from the data storage,
wherein each facet combination counter relating to the removed video data is decreased by at least one.

2. The method of claim 1, wherein when the video data is written into the storage, at least one additional aggregate counter is also generated, which represents a sum of two or more other facet counters, wherein the additional aggregate counter increases together with the counters it sums.

3. The method of claim 2, wherein facet counters form a hierarchy through aggregation.

4. The method of claim 1, wherein when the video data is stored in the storage, counters are either increased by N or decreased by N, where N is the number of indexed events in the video data.

5. The method of claim 1, wherein an absolute or relative time period relating to video data writing time is used as a facet characteristic.

6. The method of claim 1, wherein the video data source is used as a facet characteristic.

7. The method of claim 1, wherein the characteristic of user or group of users having access to the stored video data is used as a facet characteristic.

8. The method of claim 1, wherein motion detected in the relevant video data is used as a facet characteristic.

9. The method of claim 1, wherein the result of processing of video data with video- and/or audio content analysis algorithms is used as a facet characteristic.

10. The method of claim 1, wherein the characteristic or identifier of a human is used as a facet characteristic.

11. The method of claim 1, wherein the characteristic or identifier of a vehicle is used as a facet characteristic.

12. The method of claim 1, wherein an event of an external system integrated into the video surveillance system is used as a facet characteristic.

13. The method of claim 1, wherein a user tag or comment is used as a facet characteristic.

14. The method of claim 1, wherein when the video data is stored in the storage, a database index is also used for text- and number-based search through video data facet characteristics.

15. The method of claim 1, wherein multiple counters are distributed among multiple computing nodes.

16. The method of claim 1, wherein a facet counter is used to control the display of a relevant facet characteristic by a graphical user interface (GUI).

17. The method of claim 1, wherein a facet counter is used to estimate the number of search results in the video data.

18. A system for processing and storage of video data using facet characteristics, the system comprising:
a video data storage; and
a data processing device, wherein the data processing device is configured to:
write the video data containing facet characteristics into the data storage, wherein generate at least one combination of at least two facet characteristics relating to the video data;
increasing each combination counter by at least one;
running a search for video data in the data storage, wherein only those facet combinations are used, whose counters have positive values;
removing the video data from the data storage; and
decreasing each facet combination counter relating to the removed video data by at least one.
